(19) United States
(12) Patent Application Publication
(10) Pub. No.: US 2026/0184918 A1
(43) Pub. Date: Jul. 2, 2026

(54) BIODEGRADABLE COMPOSITE MATERIAL

(71) Applicant: Sogang University Research & Business Development Foundation, Seoul (KR)

(72) Inventors: Jeyoung PARK, Seoul (KR); Dong Soo HWANG, Pohang-si (KR); Seong Hyun CHUNG, Pohang-si (KR)

(73) Assignee: Sogang University Research & Business Development Foundation, Seoul (KR)

(21) Appl. No.: 19/434,750

(22) Filed: Dec. 29, 2025

(30) Foreign Application Priority Data
Jan. 2, 2025 (KR) 10-2025-0000543

(51) Int. Cl. C08L 69/00; C08G 64/30

(52) U.S. Cl. CPC C08L 69/005; C08G 64/305; C08G 2230/00; C08L 2205/14

(57) ABSTRACT

The present disclosure relates to a composite material including a polyester-carbonate copolymer and nanochitin. The composite material has an advantage in that it is suitable for use as an environmentally friendly material due to excellent biodegradability by the ester group in the copolymer, and the problem of deterioration of properties during storage and use can be minimized because hydrolysis resistance is improved by the carbonate group in the copolymer and nanochitin.

### CROSS REFERENCE TO RELATED APPLICATIONS

This application is based on and claims priority from Korean Patent Application No. 10-2025-0000543, filed on Jan. 2, 2025, with the Korean Intellectual Property Office, the disclosure of which is incorporated herein in its entirety by reference.

### TECHNICAL FIELD

The present disclosure relates to a biodegradable composite material including a polyester-carbonate copolymer and nanochitin.

### BACKGROUND

Millions of tons of plastic disposable products are produced annually, a significant portion of which is disposed of as waste and accumulated in the natural environment. This plastic waste does not decompose in nature and remains for hundreds of years, serving as one of the major causes of environmental pollution worldwide. Accordingly, research and development on biodegradable plastics are actively underway, and among them, biodegradable polymers such as polylactic acid (PLA), polyhydroxyalkanoates (PHA), and polybutylene succinate (PBS) are attracting attention.

The biodegradable plastics are polymers that mainly have an aliphatic polyester structure, and the ester bonds within the aliphatic polyester are hydrolyzed by microbial activity and moisture, thereby exhibiting biodegradability. However, since the ester bonds may also be hydrolyzed by moisture present in the atmosphere, the properties may undesirably continue to deteriorate during storage and use. That is, due to the ester bonds of the biodegradable plastics, the biodegradable plastic having low hydrolysis resistance may suffer from reduced durability during storage and use.

In order to address the above problem, a PLA-PP resin having improved hydrolysis resistance by using a carbodiimide-based compound has been devised. However, since the resin contains polypropylene, which is a non-biodegradable polymer, there is a problem in that the waste does not decompose and accumulates in the environment, making it difficult for the resin to serve as a biodegradable plastic.

In addition, methods have been proposed to enhance the hydrolysis resistance of biodegradable plastics by incorporating carbodiimide-based compounds into the resin. However, these carbodiimide-based compounds have strong chemical reactivity, which may cause the problem of producing by-products and yellowing the resin. Furthermore, the low stability of these carbodiimide-based compounds can lead to the release of hazardous substances as biodegradable plastics decompose in the environment, and therefore, biodegradable plastics containing carbodiimide-based compounds as additives were also not suitable for application. A method of incorporating aliphatic carbodiimide compounds and phosphorus-based antioxidants together into biodegradable plastics has also been devised, but there was a problem in that it was not suitable for application to biodegradable plastics due to the toxicity of the phosphorus-based antioxidants.

Accordingly, there is a need to develop a biodegradable composite material that is free of side effects such as resin yellowing and toxicity, while improving hydrolysis resistance to ensure stability during storage and use of biodegradable plastics.

### SUMMARY

An object of the present disclosure is to provide a biodegradable composite material including a polyester-carbonate copolymer and nanochitin, wherein the biodegradable composite material has improved hydrolysis resistance without side effects by introducing carbonate groups into the copolymer and nanochitin into the composite material at the same time.

In order to solve the above problem, the present disclosure provides a composite material comprising a polyester-carbonate copolymer and nanochitin, wherein the polyester-carbonate copolymer is a copolymer of a dicarboxylate-based monomer, a carbonate-based monomer, and a diol-based monomer. The molar ratio of the dicarboxylate-based monomer and the carbonate-based monomer may be 1:0.1 or more and 1:1 or less.

The molar ratio of the dicarboxylate-based monomer and the diol-based monomer may be 1:0.5 or more and 1:3 or less.

The content of the nanochitin may be 0.01 parts by weight or more and 5 parts by weight or less based on 100 parts by weight of the total polyester-carbonate copolymer.

The dicarboxylate-based monomer may be at least one selected from the group consisting of succinic acid, adipic acid, sebacic acid, suberic acid, oxalic acid, and citric acid.

The carbonate-based monomer may be at least one selected from the group consisting of diphenyl carbonate, diethyl carbonate, dimethyl carbonate, and glycerol carbonate.

The diol-based monomer may be at least one selected from the group consisting of 1,4-butanediol, 1,3-propanediol, 1,5-pentanediol, and ethylene glycol.

The polyester-carbonate copolymer may comprise repeating units represented by Chemical Formulae 1 and 2 below:

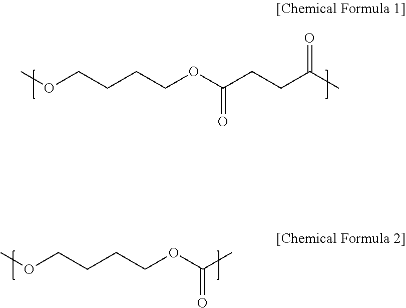

The polyester-carbonate copolymer may have a weight average molecular weight of 80,000 g/mol or more and 150,000 g/mol or less.

The nanochitin may have an average diameter of 2 nm or more and 100 nm or less.

The nanochitin may have an average length of 100 nm or more and 1 μm or less.

The nanochitin may have a deacetylated portion in an amount of 0.5% or more and 90% or less of the total repeating units.

The composite material may satisfy Equation 1 below:

$$\frac{{TT}_{60}}{{TT}_{0}} \times 100 \geq 70 ( \% ) \qquad [ Equation l ]$$

wherein TT₀ is the initial tensile toughness (MJ/m³) of the composite material, and TT₆₀ is the tensile toughness (MJ/m³) measured after exposing the composite material under conditions of a temperature of 30° C. and a relative humidity of 90% for 60 days. The composite material may satisfy the following Equation 2.

The composite material may satisfy Equation 2 below:

$$\frac{{M}_{0} - {M}_{1}}{{M}_{0}} \times 100 \geq 80 ( \% ) \qquad [ Equation 2 ]$$

wherein M₀ is the initial weight (g) of the composite material, and M₁ is the weight (g) measured after immersing the composite material in soil for one year under conditions of a temperature of 25° C. and a relative humidity of 60%.

The present disclosure provides a method of manufacturing a composite material, comprising: preparing a nanochitin dispersion (S10); mixing the nanochitin dispersion, a dicarboxylate-based monomer, a carbonate-based monomer, and a diol-based monomer to produce a monomer composition (S20); and copolymerizing the monomer composition using an in-situ polymerization method to produce a polyester-carbonate copolymer (S30).

The present disclosure provides a disposable bag comprising the composite material.

The composite material according to the present disclosure is not only environmentally friendly due to its biodegradability, but also exhibits improved hydrolysis resistance compared to conventional biodegradable plastics, thereby providing excellent stability during storage and use.

### DETAILED DESCRIPTION

Hereinafter, the respective configurations of the present disclosure will be described in more detail so that the disclosure can be readily implemented by those skilled in the art to which the present disclosure belongs. However, the following description is merely an example, and the scope of the present disclosure is not limited by the contents set forth below.

In this specification, the term “include/comprise” is used to list materials, compositions, devices, and methods useful for the present disclosure, and is not intended to be limited to the listed examples.

In this specification, the terms “about” and “substantially” are used to mean a range or approximation of a numerical value or degree, taking into account inherent manufacturing and material tolerances, and are used to prevent infringers from unfairly exploiting the disclosure, which mentions exact or absolute numerical values provided to aid understanding of the present disclosure.

In this specification, “average diameter” and “average length” are measured using a field emission scanning electron microscope (FE-SEM, e.g., Zeiss Sigma 300 VP). Specifically, the powder to be measured is dispersed in a dispersion medium and then deposited on a silicon wafer. Thereafter, the deposited wafer is sputter-coated (Q150 T Plus, Quorum Technologies Ltd.) with platinum at 15 mA for 90 seconds, and then images were captured using FE-SEM. The diameters and lengths of 100 particles are randomly measured from the captured images, and the measured values are averaged to calculate the average diameter and average length.

In this specification, “weight average molecular weight” is measured by gel permeation chromatography (GPC) using an ACQUITY APC instrument from Waters. Chloroform is used as a solvent, the column temperature is 40° C., and the flow rate is 0.6 ml/min. The measured values are converted based on standard polystyrene to obtain the weight average molecular weight.

Hereinafter, the present disclosure will be described in more detail.

The present disclosure provides a composite material.

According to one embodiment of the present disclosure, the composite material is characterized by including a polyester-carbonate copolymer and nanochitin, wherein the polyester-carbonate copolymer is a copolymer of a dicarboxylate-based monomer, a carbonate-based monomer, and a diol-based monomer. Specifically, in the composite material, the polyester-carbonate copolymer is hydrophobic, and the nanochitin is hydrophilic, so that they may coexist in a state in which they are dispersed and mixed with each other. Conventional biodegradable plastics including polyester have the advantage of excellent biodegradability due to the hydrolysis of the ester groups. However, the acid terminal groups generated when the ester groups are hydrolyzed may accelerate the hydrolysis reaction in a chain manner, resulting in the disadvantage that the properties of the biodegradable plastics may rapidly deteriorate during storage and use. In contrast, the polyester-carbonate copolymer can have excellent hydrolysis resistance because it contains carbonate groups that are not hydrolyzed by acid terminal groups in addition to ester groups with excellent biodegradability. In addition, the mechanical strength and heat resistance of the copolymer may also be excellent due to the carbonate groups, making the composite material suitable for long-term storage and use. In addition, since the polyester-carbonate copolymer contains a diol-based monomer, the flexibility of the polymer can be improved, and thus properties such as tensile toughness can also be excellent.

In addition, the composite material of the present disclosure is characterized by including nanochitin. Chitin is a compound having a structure in which n-acetylglucosamine units are linked by glycosidic bonds, and the nanochitin refers to a material obtained by processing the chitin in nano units. The form of the nanochitin may be, for example, a chitin nanofiber having a fibrous structure or a chitin nanowhisker having a rod-shaped structure, and preferably, a chitin nanowhisker. The size of the chitin nanofiber or chitin nanowhisker will be described later. Since the chitin includes an amine functional group in the molecule, the composite material can have excellent hydrolysis resistance by including the nanochitin, because the amine functional group of the nanochitin can neutralize the acid terminal group generated when the ester group of the polyester-carbonate copolymer is hydrolyzed. The polyester-carbonate copolymer may be a random copolymer, a block copolymer, or an alternating copolymer, and specifically, may be a random copolymer.

According to one embodiment of the present disclosure, the molar ratio of the dicarboxylate-based monomer and the carbonate-based monomer may be 1:0.1 or more and 1:1 or less. Specifically, the molar ratio of the dicarboxylate-based monomer and the carbonate-based monomer may be 1:0.1 or more, 1:0.15 or more, 1:0.2 or more, 1:0.25 or more, 1:0.3 or more, 1:0.35 or more, 1:0.4 or more, 1:0.45 or more, or 1:0.5 or more, and may also be 1:1 or less, 1:0.9 or less, 1:0.8 or less, 1:0.7 or less, 1:0.6 or less, 1:0.5 or less, 1:0.4 or less, or 1:0.3 or less. When the molar ratio of the dicarboxylate-based monomer and the carbonate-based monomer satisfies the above range, both the dicarboxylate-based monomer, which can enhance the biodegradability of the polyester-carbonate copolymer, and the carbonate-based monomer, which can improve hydrolysis resistance, can be sufficiently included, so that the biodegradability and hydrolysis resistance of the composite material can be excellent in balance.

According to one embodiment of the present disclosure, the molar ratio of the dicarboxylate-based monomer and the diol-based monomer may be 1:0.5 or more and 1:3 or less. Specifically, the molar ratio of the dicarboxylate-based monomer and the diol-based monomer may be 1:0.5 or more, 1:0.6 or more, 1:0.7 or more, 1:0.8 or more, 1:0.9 or more, 1:1 or more, 1:1.1 or more, 1:1.2 or more, 1:1.3 or more, 1:1.4 or more, 1:1.5 or more, 1:1.6 or more, 1:1.7 or more, 1:1.8 or more, 1:1.9 or more, or 1:2 or more, and may also be 1:3 or less, 1:2.9 or less, 1:2.8 or less, 1:2.7 or less, 1:2.6 or less, 1:2.5 or less, 1:2.4 or less, 1:2.3 or less, 1:2.2 or less, 1:2.1 or less, or 1:2 or less. When the molar ratio of the dicarboxylate-based monomer and the diol-based monomer satisfies the above range, the diol-based monomer, which can improve the flexibility of the polyester-carbonate copolymer, can be sufficiently included in the copolymer, and thus the composite material can have excellent tensile toughness.

According to one embodiment of the present disclosure, the content of the nanochitin may be 0.01 parts by weight or more and 5 parts by weight or less based on 100 parts by weight of the total polyester-carbonate copolymer. Specifically, the content of the nanochitin may be 0.01 parts by weight or more, 0.05 parts by weight or more, 0.1 parts by weight or more, 0.3 parts by weight or more, 0.5 parts by weight or more, or 1 part by weight or more, and may also be 5 parts by weight or less, 3 parts by weight or less, 1 part by weight or less, 0.5 parts by weight or less, 0.3 parts by weight or less, 0.1 parts by weight or less, or 0.05 parts by weight or less, based on 100 parts by weight of the total polyester-carbonate copolymer. When the content of the nanochitin satisfies the above range, nanochitin containing a sufficient amount of amine functional groups capable of neutralizing acid terminal groups formed by hydrolysis of the ester groups of the polyester-carbonate copolymer can be present in the composite material, thereby effectively improving the hydrolysis resistance of the composite material.

According to one embodiment of the present disclosure, the dicarboxylate-based monomer may be at least one selected from the group consisting of succinic acid, adipic acid, sebacic acid, suberic acid, oxalic acid, and citric acid. Specifically, the dicarboxylate-based monomer may be succinic acid. Since the above-listed monomers contain two or more carboxyl groups, they can promote hydrolysis under atmospheric conditions when included in the polyester-carbonate copolymer, thereby improving the biodegradability of the copolymer and the composite material including the copolymer.

According to one embodiment of the present disclosure, the carbonate-based monomer may be at least one selected from the group consisting of diphenyl carbonate, diethyl carbonate, dimethyl carbonate, and glycerol carbonate. Specifically, the carbonate-based monomer may be diphenyl carbonate. Since the monomers listed above contain carbonate groups, they can slow down the hydrolysis chain reaction of acid terminals formed by decomposed ester groups when included in the polyester-carbonate copolymer, thereby improving the hydrolysis resistance of the composite materials compared to conventional plastics containing polyester, and thus improving the stability during storage and use.

According to one embodiment of the present disclosure, the diol-based monomer may be at least one selected from the group consisting of 1,4-butanediol, 1,3-propanediol, 1,5-pentanediol, and ethylene glycol. Specifically, the diol-based monomer may be 1,4-butanediol. The monomers listed above contain two or more alcohol groups and, when included in the polyester-carbonate copolymer, can improve the flexibility of the polymer. Therefore, the polyester-carbonate copolymer can exhibit excellent tensile toughness.

According to one embodiment of the present disclosure, the polyester-carbonate copolymer may include repeating units represented by Chemical Formulae 1 and 2 below:

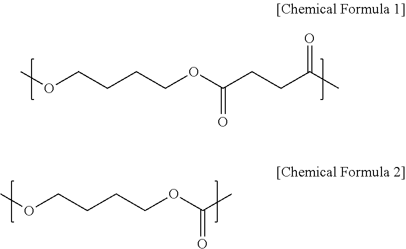

Specifically, the polyester-carbonate copolymer is a copolymer polymerized from the dicarboxylate-based monomer, the carbonate-based monomer, and the diol-based monomer, and may be a random copolymer, a block copolymer, or an alternating copolymer including repeating units of Chemical Formulae 1 and 2, and more specifically, may be a random copolymer in which the repeating units of Chemical Formulae 1 and 2 are randomly linked. The repeating unit of Chemical Formula 1 may be formed by copolymerizing the dicarboxylate-based monomer and the diol-based monomer, and the repeating unit of Chemical Formula 2 may be formed by polymerizing the carbonate-based monomer. The polyester-carbonate copolymer including the repeating units of Formulas 1 and 2 can not only exhibit excellent flexibility and mechanical strength in balance, but also exhibit well-balanced and excellent biodegradability and hydrolysis resistance, and thus the composite material can exhibit excellent stability during storage and use, while also being environmentally friendly.

According to one embodiment of the present disclosure, the polyester-carbonate copolymer may have a weight average molecular weight of 80,000 g/mol or more and 150,000 g/mol or less. Specifically, the polyester-carbonate copolymer may have a weight average molecular weight of 80,000 g/mol or more, 85,000 g/mol or more, 90,000 g/mol or more, 95,000 g/mol or more, 100,000 g/mol or more, 105,000 g/mol or more, or 110,000 g/mol or more, and may also have a weight average molecular weight of 150,000 g/mol or less, 145,000 g/mol or less, 140,000 g/mol or less, 130,000 g/mol or less, 125,000 g/mol or less, 120,000 g/mol or less, 115,000 g/mol or less, 110,000 g/mol or less, 105,000 g/mol or less, or 100,000 g/mol or less. When the weight average molecular weight of the polyester-carbonate copolymer satisfies the above range, the copolymer length is sufficiently long to impart flexibility to the composite material, while also minimizing the problem of the copolymer's mechanical properties deteriorating due to excessively high molecular weight.

According to one embodiment of the present disclosure, the nanochitin may have an average diameter of 2 nm or more and 100 nm or less. The nanochitin may also be a chitin nanowhisker having a rod-shaped structure, wherein the nanochitin may be a chitin nanowhisker having an average diameter of 2 nm or more and 100 nm or less. Specifically, the nanochitin may have an average diameter of 2 nm or more, 10 nm or more, 20 nm or more, or 30 nm or more, and also 100 nm or less, 90 nm or less, 80 nm or less, 70 nm or less, 60 nm or less, 50 nm or less, or 40 nm or less. When the average diameter of the nanochitin satisfies the above range, the nanochitin can exhibit high strength and crystallinity, thereby enhancing the mechanical strength of the composite material. Furthermore, when the average diameter of the nanochitin satisfies the above range, the nanochitin can be uniformly dispersed within the composite material, allowing the amine functional groups contained in the nanochitin to neutralize the acid terminal groups formed by the decomposition of ester groups throughout the composite material, and as a result, effectively improving the hydrolysis resistance of the composite material.

According to one embodiment of the present disclosure, the nanochitin may have an average length of 100 nm or more and 1 μm or less. The nanochitin may be a chitin nanowhisker having the rod-shaped structure as described above, wherein the nanochitin may be a chitin nanowhisker having an average length of 100 nm or more and 1 μm or less. Specifically, the nanochitin may have an average length of 100 nm or more, 150 nm or more, 200 nm or more, 250 nm or more, or 300 nm or more, and also 1 μm or less, 900 nm or less, 800 nm or less, 700 nm or less, 600 nm or less, 500 nm or less, 400 nm or less, 300 nm or less, or 200 nm or less. When the average length of the nanochitin satisfies the above range, the nanochitin can exhibit high strength and crystallinity, thereby enhancing the mechanical strength of the composite material. Furthermore, when the average length of the nanochitin satisfies the above range, the nanochitin can be uniformly dispersed within the composite material, allowing the amine functional groups contained in the nanochitin to neutralize the acid terminal groups formed by the decomposition of ester groups throughout the composite material, and as a result, effectively improving the hydrolysis resistance of the composite material.

According to one embodiment of the present disclosure, the nanochitin may have a deacetylated portion in an amount of 0.5% or more and 90% or less of the total repeating units. Specifically, the nanochitin may include a deacetylated portion as represented by Chemical Formula 3 below:

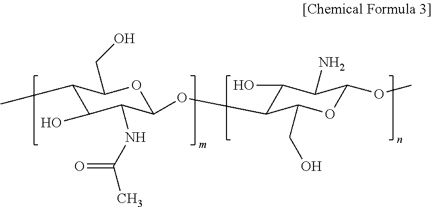

Specifically, the deacetylated portion of the nanochitin may account for 0.5% or more, 1% or more, 2% or more, 3% or more, or 4% or more of the total repeating units of the nanochitin, and may also be 90% or less, 50% or less, 30% or less, 10% or less, 5% or less, or 1% or less. When the content of the deacetylated portion in the nanochitin satisfies the above range, the amine functional group can effectively neutralize the acid terminal group formed by the decomposition of the ester group within the composite material, thereby enhancing the hydrolysis resistance of the composite material.

According to one embodiment of the present disclosure, the composite material may satisfy Equation 1 below:

$$\frac{{TT}_{60}}{{TT}_{0}} \times 100 \geq 70 ( \% ) \qquad [ Equation l ]$$

wherein TT₀ is the initial tensile toughness (MJ/m³) of the composite material, and TT₆₀ is the tensile toughness (MJ/m³) measured after exposing the composite material under conditions of a temperature of 30° C. and a relative humidity of 90% for 60 days. The tensile toughness may be measured according to the standard test method ASTM D638 using Instron 5943 equipment under conditions of a 1 kN load cell and a speed of 100 mm/min. Equation 1 may be evaluated as the tensile toughness retention rate of the composite material. Specifically, the tensile toughness of the composite material represented by Equation 1 may be 70% or more, 80% or more, 90% or more, or 95% or more, and also 99% or less, 95% or less, or 90% or less. When the tensile toughness retention rate of the composite material satisfies the above range, the composite material with excellent hydrolysis resistance can maintain a high level of tensile toughness over time, making it easy to use and store.

According to one embodiment of the present disclosure, the composite material may satisfy Equation 2 below:

$$\frac{{M}_{0} - {M}_{1}}{{M}_{0}} \times 100 \geq 80 ( \% ) \qquad [ Equation 2 ]$$

wherein M₀ is the initial weight (g) of the composite material, and M₁ is the weight (g) measured after immersing the composite material in soil for one year under conditions of a temperature of 25° C. and a relative humidity of 608. The M₀ may be the weight of a film-shaped specimen measured immediately after the composite material is fabricated into the specimen, and the M₁ may be the weight of the specimen measured one year after the specimen is immersed in soil prepared by mixing topsoil and earthworm castings at a weight ratio of 7:3 and maintained under conditions of a temperature of 25° C. and a relative humidity of 60%. Equation 2 may be evaluated as the biodegradation rate of the composite material. Specifically, the biodegradation rate of the composite material represented by Equation 2 may be 80% or more, 85% or more, 90% or more, or 95% or more, and also 99% or less, or 95% or less. When the biodegradation rate of the composite material satisfies the above range, the composite material can exhibit excellent soil biodegradability, such that 80% by weight or more of the composite material can be biodegraded in soil after one year, making it suitable for use in biodegradable materials.

The present disclosure provides a method of manufacturing a composite material.

The method of manufacturing the composite material may be a method of manufacturing the composite material described above. Any description of the method of manufacturing the composite material that overlaps with the description of the composite material will be omitted.

According to one embodiment of the present disclosure, the method of manufacturing the composite material may include steps of: preparing a nanochitin dispersion (S10); mixing the nanochitin dispersion, a dicarboxylate-based monomer, a carbonate-based monomer, and a diol-based monomer to produce a monomer composition (S20); and copolymerizing the monomer composition using an in-situ polymerization method to produce a polyester-carbonate copolymer (S30). The method of manufacturing the composite material can manufacture a composite material having excellent biodegradability and hydrolysis resistance in balance by manufacturing a composite material including a polyester-carbonate copolymer and nanochitin through the above-described steps.

The step (S10) may be a step of preparing a nanochitin dispersion by introducing nanochitin into a solvent. Next, the step (S20) may be a step of preparing a monomer composition by mixing the nanochitin dispersion prepared in the step (S10), a dicarboxylate-based monomer, a carbonate-based monomer, and a diol-based monomer. The monomer composition may be prepared by introducing the nanochitin dispersion and the monomers described above into a reactor together. Alternatively, the monomer composition may be prepared by mixing the nanochitin dispersion and the monomers in advance before being introduced into the reactor, and then introduced into the reactor.

The step (S30) may be a step of copolymerizing the monomer composition using an in-situ polymerization method to produce a polyester-carbonate copolymer. The nanochitin contained in the nanochitin dispersion in the step (S30) does not function as a monomer for polymerization and thus may not form the polyester-carbonate copolymer. The step (S30) uses an in-situ polymerization method, such that the polymerization of the monomers occurs with the nanochitin dispersed in the monomer composition, and thus, the nanochitin can be evenly dispersed and present within the finally manufactured composite material. Therefore, the amine functional group of the nanochitin evenly dispersed on the surface of the polyester-carbonate copolymer can effectively reduce the hydrolysis of the polyester-carbonate copolymer, and thus the hydrolysis resistance of the composite material can be excellent.

The present disclosure provides a disposable bag.

The disposable bag may include the composite material described above. In the following, any description of the disposable bag including the composite material that overlaps with the description of the composite material will be omitted.

According to one embodiment of the present disclosure, the disposable bag may include the composite material. The disposable bag may be manufactured from the composite material through extrusion or injection molding, and may further include other additives, such as inks and antibacterial agents, that may be used for disposable bags in addition to the composite material. By including the composite material, the disposable bag has the advantage of being environmentally friendly in that it can be disposed of without environmental damage even after being buried in the soil after use due to its high biodegradability. Furthermore, since the disposable bag includes the composite material with improved hydrolysis resistance, unlike conventional biodegradable plastics, the problem of hydrolysis by moisture in the air when the disposable bag is stored before use can be reduced, and the problem of deterioration of properties due to moisture during the process of using the disposable bag can be minimized.

Hereinafter, the present disclosure will be described in detail by way of examples. However, the examples according to the present disclosure may be modified in various different forms, and the scope of the present disclosure is not construed as being limited to the following examples. The examples of the present specification are provided to explain the present disclosure more completely to those skilled in the art.

### EXAMPLES AND COMPARATIVE EXAMPLES

### Manufacture of Biodegradable Composite Materials

### Example 1

50 mg of chitin nanowhiskers (average diameter: approximately 35 nm, average length: 230 nm, deacetylated portion of total repeating units: 4.5%) were added to water and treated with a probe-tip sonicator (VCX 750) for 15 minutes to prepare a nanochitin dispersion.

Succinic acid (56.0 g, 0.474 mol), diphenyl carbonate (33.9 g, 0.158 mol), 1,4-butanediol (68.4 g, 0.759 mol), titanium (IV) butoxide (0.108 g), and the nanochitin dispersion were introduced into a reactor, and an esterification reaction was carried out at 200° C. by gradually increasing the temperature while stirring.

Next, the temperature of the reactor was gradually increased to 240° C. while the vacuum was gradually reduced to 0.5 torr, so that a condensation polymerization n reaction of the succinic acid, diphenyl carbonate, and 1,4-butanediol was carried out. The condensation polymerization reaction was terminated when the torque remained constant for 5 minutes, and after releasing the vacuum, the product was coagulated in water and recovered.

Subsequently, the recovered product was vacuum-dried at a temperature of 60° C. for 48 hours to manufacture 98 g of a composite material including a polyester-carbonate copolymer (weight average molecular weight: 120,500 g/mol) and nanochitin obtained through the condensation polymerization reaction.

### Example 2

98 g of a composite material including a polyester-carbonate copolymer (weight average molecular weight: 105,000 g/mol) and nanochitin was manufactured in the same manner as in Example 1, except that 100 mg of the chitin nanowiskers was added to prepare a nanochitin dispersion.

### Example 3

98 g of a composite material including a polyester-carbonate copolymer (weight average molecular weight: 96,000 g/mol) and nanochitin was manufactured in the same manner as in Example 1, except that 300 mg of the chitin nanowiskers was added to prepare a nanochitin dispersion.

### Example 4

98 g of a composite material including a polyester-carbonate copolymer (weight average molecular weight: 93,000 g/mol) and nanochitin was manufactured in the same manner as in Example 1, except that 500 mg of the chitin nanowiskers was added to prepare a nanochitin dispersion.

### Example 5

98 g of a composite material including a polyester-carbonate copolymer (weight average molecular weight: 142,000 g/mol) and nanochitin was manufactured in the same manner as in Example 3, except that sebacic acid was used instead of succinic acid as a dicarboxylate-based monomer to prepare the copolymer.

### Example 6

98 g of a composite material including a polyester-carbonate copolymer (weight average molecular weight: 89,000 g/mol) and nanochitin was manufactured in the same manner as in Example 3, except that dimethyl carbonate was used instead of diphenyl carbonate as a carbonate-based monomer to prepare the copolymer.

### Example 7

98 g of a composite material including a polyester-carbonate copolymer (weight average molecular weight: 135,000 g/mol) and nanochitin was manufactured in the same manner as in Example 3, except that 1,5-pentanediol was used instead of 1,4-butanediol as a diol-based monomer to prepare the copolymer.

### Comparative Example 1

98 g of a composite material including a polyester-carbonate copolymer (weight average molecular weight: 130,000 g/mol) and nanocellulose was manufactured in the same manner as in Example 1, except that 50 mg of nanocellulose fibers were added instead of the chitin nanowiskers to prepare a nanocellulose dispersion.

### Comparative Example 2

98 g of a composite material including a polyester-carbonate copolymer (weight average molecular weight: 117,000 g/mol) and nanocellulose was manufactured in the same manner as in Example 1, except that 100 mg of nanocellulose fibers were added instead of the chitin nanowiskers to prepare a nanocellulose dispersion.

### Comparative Example 3

98 g of a composite material including a polyester-carbonate copolymer (weight average molecular weight: 102,000 g/mol) and nanocellulose was manufactured in the same manner as in Example 1, except that 300 mg of nanocellulose fibers were added instead of the chitin nanowiskers to prepare a nanocellulose dispersion.

### Comparative Example 4

98 g of a composite material including a polyester-carbonate copolymer (weight average molecular weight: 96,000 g/mol) and nanocellulose was manufactured in the same manner as in Example 1, except that 500 mg of nanocellulose fibers were added instead of the chitin nanowiskers to prepare a nanocellulose dispersion.

### Comparative Example 5

Polybutylene succinate (PBS) (Solpol 1000M, SOLTECH Co., Ltd.) having a weight average molecular weight of 116,000 g/mol was prepared.

### Comparative Example 6

98 g of a polyester-carbonate copolymer (weight average molecular weight: 104,000 g/mol) was manufactured in the same manner as in Example 1, except that the chitin nanowhiskers were not added and the condensation polymerization reaction was performed.

### Experimental Example

### (1) Evaluation of Tensile Toughness and Tensile Toughness Retention Rate of Composite Materials

The composite materials or copolymers of the Examples and Comparative Examples were melted at a temperature of 160° C. and then subjected to a blown film process through extrusion. The continuous film (20 μm thick) obtained through this process was cut with a dog-bone-shaped cutter to prepare specimens. Tensile stress and elongation curves were obtained according to the standard test method ASTM D638 using Instron 5943 equipment under conditions of a 1 kN load cell and a speed of 100 mm/min, and the curves were integrated to measure the tensile toughness, which is shown in Table 1 below.

In addition, the temperature and relative humidity of a constant temperature and humidity chamber (JSRH-500CP, JS Research) were set to 30° C. and 90%, respectively, and the blown film was hydrolyzed using this chamber. The hydrolysis of the film was performed for 60 days in the above exposure environment, and the tensile toughness was measured after 40 and 60 days. A ratio of the tensile toughness at each measurement point to the initial tensile toughness was evaluated as the tensile toughness retention rate, which is shown in Table 1 below. Specifically, the tensile toughness retention rate was evaluated as follows:

$$\frac{{TT}_{t}}{{TT}_{0}} ( \% )$$

wherein TT₀ is the initial tensile toughness (MJ/m³) of the composite material specimens of the Examples and Comparative Examples, and TTₜ is the tensile toughness (MJ/m³) measured after exposing the composite material under conditions of a temperature of 30° C. and a relative humidity of 90% for a specific period of time.

TABLE 1

| | Nanochitin | Nanocellulose | | | |
|---|---|---|---|---|---|
| | content in | content in | Tensile | Tensile toughness | |
| | composite | composite | tough- | retention rate (%) | |
| | material | material | ness | After | After |
| Division | (wt %) | (wt %) | (MJ/m³) | 40 days | 60 days |
| Example 1 | 0.05 | — | 132 | 89 | 72 |
| Example 2 | 0.1 | — | 159 | 97 | 96 |
| Example 3 | 0.3 | — | 144 | 99 | 97 |
| Example 4 | 0.5 | — | 148 | 91 | 84 |
| Example 5 | 0.3 | — | 190 | 75 | 71 |
| Example 6 | 0.3 | — | 138 | 72 | 70 |
| Example 7 | 0.3 | — | 175 | 75 | 71 |
| Comparative | — | 0.05 | 149 | 52 | 33 |
| Example 1 | | | | | |
| Comparative | — | 0.1 | 164 | 42 | 22 |
| Example 2 | | | | | |
| Comparative | — | 0.3 | 153 | 30 | 14 |
| Example 3 | | | | | |
| Comparative | — | 0.5 | 146 | 37 | 23 |
| Example 4 | | | | | |
| Comparative | — | — | 181 | 28 | 8 |
| Example 5 | | | | | |
| Comparative | — | — | 46 | 13 | 11 |
| Example 6 | | | | | |

As shown in Table 1, it can be confirmed that the composite materials of the Examples have excellent tensile toughness compared to the polyester-carbonate copolymer of Comparative Example 6, which does not contain nanochitin, and have improved hydrolysis resistance by the nanochitin, thereby maintaining a high level of tensile toughness even over time. Also, the composite materials of Comparative Examples 1 to 4, which contain nanocellulose not containing an amine functional group, have poor hydrolysis resistance, unlike the composite materials of the Examples containing the nanochitin, resulting in a significant decrease in tensile toughness over time. Furthermore, it can be confirmed that the polybutylene succinate of Comparative Example 5 also has remarkably poor tensile toughness retention rate, compared to the Examples.

As shown in Table 1, it can be confirmed that all of the composite materials of Examples 1 to 7 exhibit excellent hydrolysis resistance, with a tensile toughness retention rate of 70% or more as measured after 60 days. In particular, even when including the same amount of nanochitin, Example 3, which includes succinic acid, diphenyl carbonate, and 1,4-butanediol as monomers, was confirmed to have a more excellent tensile toughness retention rate than Examples 5 to 7.

### (2) Evaluation of Biodegradation Rate in Soil

The composite materials or copolymers of the Examples and Comparative Examples were melted at a temperature of 190° C. to prepare hot-pressed film specimens (thickness 200 μm, 3 cm×3 cm). In order to evaluate a biodegradation rate in soil, soil was prepared by mixing topsoil and earthworm castings at a weight ratio of 7:3 to simulate agricultural soil. The film specimens were immersed in the soil and maintained under conditions of a temperature of 25° C. and a relative humidity of 60%, and the weight was measured every three weeks for 12 months. A ratio of the weight after 6 months and 12 months to the initial film specimen weight was evaluated as the soil biodegradation rate, and is shown in Table 2 below. Specifically, the biodegradation rate in the soil was evaluated as follows:

$$\frac{\text{?}}{{M}_{0}} \times 100 \geq 80 ( \% )$$

$$\text{?} \text{indicates text missing or illegible when filed}$$

wherein M₀ is the initial weight (g) of the composite material specimens of the Examples and Comparative examples, and Mₜ is the weight (g) measured after immersing the composite material in soil for a specific period of time under conditions of a temperature of 25° C. and a relative humidity of 60%.

TABLE 2

| | Nanochitin | Nanocellulose | | |
|---|---|---|---|---|
| | content in | content in | Biodegradation | |
| | composite | composite | rate in soil (%) | |
| | material | material | After | After |
| Division | (wt %) | (wt %) | 6 months | 1 year |
| Example 1 | 0.05 | — | 34 | 95 |
| Example 2 | 0.1 | — | 33 | 96 |
| Example 3 | 0.3 | — | 38 | 100 |
| Example 4 | 0.5 | — | 36 | 96 |
| Example 5 | 0.3 | — | 48 | 100 |
| Example 6 | 0.3 | — | 37 | 100 |
| Example 7 | 0.3 | — | 45 | 100 |
| Comparative | — | 0.05 | 35 | 94 |
| Example 1 | | | | |
| Comparative | — | 0.1 | 32 | 92 |
| Example 2 | | | | |
| Comparative | — | 0.3 | 34 | 94 |
| Example 3 | | | | |
| Comparative | — | 0.5 | 37 | 100 |
| Example 4 | | | | |
| Comparative | — | — | 16 | 67 |
| Example 5 | | | | |
| Comparative | — | — | 38 | 100 |
| Example 6 | | | | |

As shown in Table 2 above, it can be confirmed that the composite materials of the Examples have excellent biodegradability, and thus 95% or more of the specimen was biodegraded when one year has elapsed after soil immersion. In particular, the composite material specimens of the Examples showed remarkable biodegradability compared to the specimen of Comparative Example 5, which uses the polybutylene succinate copolymer instead of the polyester-carbonate copolymer. From the experimental results, it can be confirmed that the composite material of the present disclosure has improved hydrolysis resistance, ensuring superior safety in use and storage, and is suitable for use as an environmentally friendly material because most of the material can be biodegraded within 6 months or 1 year when it is buried in the soil after use.

As shown in Table 2, all of the composite materials of Examples 1 to 7 exhibited excellent biodegradability. In particular, in the case of Examples 3 and 5 to 7, in which the content of nanochitin was 0.3 wt %, it was confirmed that the biodegradation rate after one year was 100%, indicating very excellent biodegradability.

What is claimed is:

1. A composite material comprising:
a polyester-carbonate copolymer and nanochitin,
wherein the polyester-carbonate copolymer is a copolymer of a dicarboxylate-based monomer, a carbonate-based monomer, and a diol-based monomer.

2. The composite material of claim 1, wherein the molar ratio of the dicarboxylate-based monomer and the carbonate-based monomer is 1:0.1 or more and 1:1 or less.

3. The composite material of claim 1, wherein the molar ratio of the dicarboxylate-based monomer and the diol-based monomer is 1:0.5 or more and 1:3 or less.

4. The composite material of claim 1, wherein the content of the nanochitin is 0.01 parts by weight or more and 5 parts by weight or less based on 100 parts by weight of the total polyester-carbonate copolymer.

5. The composite material of claim 1, wherein the dicarboxylate-based monomer is at least one selected from the group consisting of succinic acid, adipic acid, sebacic acid, suberic acid, oxalic acid, and citric acid.

6. The composite material of claim 1, wherein the carbonate-based monomer is at least one selected from the group consisting of diphenyl carbonate, diethyl carbonate, dimethyl carbonate, and glycerol carbonate.

7. The composite material of claim 1, wherein the diol-based monomer is at least one selected from the group consisting of 1,4-butanediol, 1,3-propanediol, 1,5-pentanediol, and ethylene glycol.

8. The composite material of claim 1, wherein the polyester-carbonate copolymer comprises repeating units represented by Chemical Formulae 1 and 2 below:

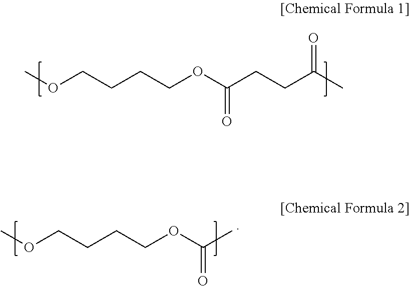

9. The composite material of claim 1, wherein the polyester-carbonate copolymer has a weight average molecular weight of 80,000 g/mol or more and 150,000 g/mol or less.

10. The composite material of claim 1, wherein the nanochitin has an average diameter of 2 nm or more and 100 nm or less.

11. The composite material of claim 1, wherein the nanochitin has an average length of 100 nm or more and 1 μm or less.

12. The composite material of claim 1, wherein the nanochitin has a deacetylated portion in an amount of 0.5% or more and 90% or less of the total repeating units.

13. The composite material of claim 1, wherein the composite material satisfies Equation 1 below:
$$\frac{{TT}_{60}}{{TT}_{0}} \times 100 \geq 70 ( \% ) \qquad [ Equation l ]$$
wherein TT₀ is the initial tensile toughness (MJ/m³) of the composite material, and TT₆₀ is the tensile toughness (MJ/m³) measured after exposing the composite material under conditions of a temperature of 30° C. and a relative humidity of 90% for 60 days.

14. The composite material of claim 1, wherein the composite material satisfies Equation 2 below:
$$\frac{{M}_{0} - {M}_{1}}{{M}_{0}} \times 100 \geq 80 ( \% ) \qquad [ Equation 2 ]$$
wherein M₀ is the initial weight (g) of the composite material, and M₁ is the weight (g) measured after immersing the composite material in soil for one year under conditions of a temperature of 25° C. and a relative humidity of 60%.

15. A method of manufacturing a composite material, comprising:
preparing a nanochitin dispersion (S10);
mixing the nanochitin dispersion, a dicarboxylate-based monomer, a carbonate-based monomer, and a diol-based monomer to produce a monomer composition (S20); and
copolymerizing the monomer composition using an in-situ polymerization method to produce a polyester-carbonate copolymer (S30).

16. A disposable bag comprising the composite material of claim 1.
